(19) United States
(12) Patent Application Publication
(10) Pub. No.: US 2020/0376722 A1
(43) Pub. Date: Dec. 3, 2020

(54) Air eliminator valve for composite manufacturing

(71) Applicant: VIETTEL GROUP, Ha Noi City (VN)

(72) Inventors: ANH VU NGUYEN, Ha Noi City (VN); KY NAM PHAM, Ha Noi City (VN); TIEN DAT VU, Ha Noi City (VN); QUYET THANG TRAN, Nghia Hung District (VN); XUAN THUC NGUYEN, Thuan Thanh District (VN); THI HUYEN PHAM, Hanoi City (VN)

(73) Assignee: VIETTEL GROUP, Ha Noi City (VN)

(21) Appl. No.: 16/884,360

(22) Filed: May 27, 2020

(30) Foreign Application Priority Data
May 27, 2019 (VN) 1-2019-02745

(51) Int. Cl. B29C 37/00; F16K 24/04; B01D 19/00

(52) U.S. Cl. CPC B29C 37/0064; B01D 19/0078; F16K 24/044

(57) ABSTRACT

The air eliminator valve helps to eliminate air in the plastic resin used for composite products manufacturing. During operation, it continuously eliminates the air bubbles in the plastic resin running through the valve, and then transfers the filtered plastic resin into the mold. The design of the air eliminator valve consists of: inlet, inlet lock, air vent, upper cover, main body, ultrasonic generator, outlet lock and outlet. In which, the ultrasonic generator plays a role in generating ultrasonic waves to the plastic resin in the valve body that allows speeding up the air releasing process out the plastic resin. The air content in the valve could go out through the air vent on the upper cover, its status “open/close” is controlled by airlock with automatic response mechanism.

### FIELD OF THE INVENTION

The invention proposes an auxiliary valve used for eliminating air bubbles in the plastic resin used for the fabrication of composite products.

### BACKGROUND OF THE INVENTION

Composite materials due to their excellent mechanical properties (high strength, high rigidity and light density . . . ) are increasingly applied to replace metal materials in the products in the field of aviation, spacecraft, automobile . . . .

For composite products in high technology fields, they must meet strict quality requirements, especially high consistency or low pore content. Because the pores in composite materials reduce their mechanical properties, cause local damage and increase moisture absorption into composite structures. Therefore, the elimination of the air bubbles in the plastic resin is a necessary process for the fabrication of high quality composite products.

Currently in the field of composite manufacturing, there are not many specialized equipment for filtering plastic resin. At the present, the main filtering methods are pre-treatment processes as follows:
Use vacuum pump: Plastic resin mixed with hardening additives is put in an airtight tank which is connected to a vacuum pump. When the vacuum pump is turned on, it draws air out of the tank that augments the pressure difference at the open surface of the mixed resin. Therefore, the air releasing process on the open surface of the mixed resin is speeded up.
Use an ultrasonic tank: in this method, the container of plastic resin mixed with hardening additives is placed in an ultrasonic tank containing a liquid as the transmission medium. When the ultrasonic tank functions, the ultrasonic waves will be transmitted through the liquid to the plastic resin that increases the mobility of air bubbles in the plastic resin. Therefore, the air bubbles could move up and release faster at the open surface. The ultrasonic waves are highly effective for eliminating gas in plastic resin. However, the method of using the ultrasonic tank has the some disadvantages. Firstly, under the influence of ultrasonic waves, the properties of plastic resin are changed. Specifically, the viscosity of the plastic resin is decreased prior the molding injection process. That leads to a higher difficulty in the injection molding process and a longer manufacturing time. Secondly, the method requires time and effort for manipulating and performing the air eliminating process.

In order to speed up the composite product manufacturing process, the authors propose the design of a device used for eliminating air bubbles in the plastic resin used in composite product manufacturing.

### TECHNICAL BACKGROUND OF THE INVENTION

The invention proposes an auxiliary device used for eliminating air bubbles in the plastic resin used for composite product fabrication. Specifically, it is an air eliminator valve that is connected between the plastic resin storage tank and the mold. The air eliminator valve allows eliminating the air bubbles in the plastic resins from storage tank passing through the valve, and then transfers the filtered plastic resins into the mold.

The air eliminator valve consists of: inlet, valve body, outlet, air vent and an ultrasonic generator integrated in the valve body. In which, the ultrasonic generator plays a role in generating ultrasonic waves to the plastic resin passing through the valve body. These ultrasonic waves allow accelerating the air releasing speed in the plastic resin. Therefore, the air content in the plastic resin is reduced and its consistency is enhanced before the process of transferring plastic resin into the mold.

### BRIEF DESCRIPTION OF THE DRAWINGS

FIG. 1: Design of air eliminator valve used for composite manufacturing

### DESCRIPTION OF THE SPECIFIC EMBODIMENTS

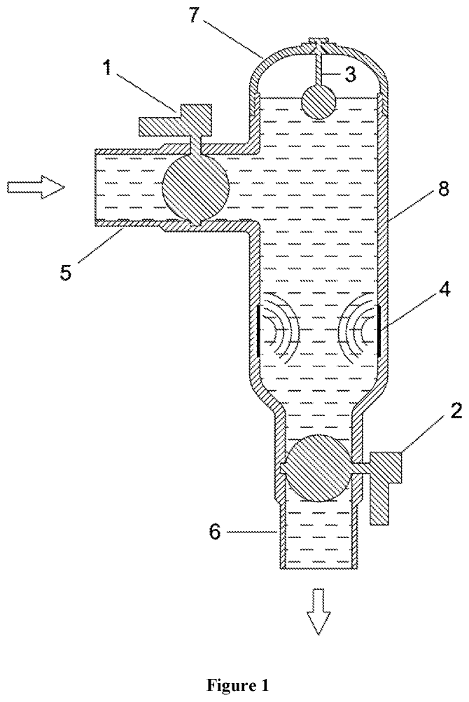

Refer to the FIG. 1, the air eliminator valve for composite product manufacturing proposed in the invention is composed of the following main details: inlet 5, inlet lock 1, air vent 3, upper cover 7, main body 8, ultrasonic generator 4, outlet lock 2 and outlet 6. In which:

Valve body 8 is composed of two cylinder structures which are perpendicularly mounted; one cylinder end is closed by the upper cover 7. On upper cover 7, there is the air vent 3 that controls the air releasing out the valve. There is a free space between the upper cover and the open surface of the resin that contains the air releasing from the plastic resin during the air separation process. The valve body has the inlet 5 which could be connected to a plastic resin storage tank. The plastic resin flow running from the plastic resin tank to the valve can be controlled by the “close/open” status of the inlet lock 1. The outlet 6 is the connecting end with the mold, the plastic resin flow through the outlet is controlled by the “open/close” status of the outlet lock 2. In the valve main body there is the ultrasonic generator 4, generally made of piezoelectric material.

The inlet lock 1 and outlet lock 2 in the invention are common locking mechanisms, having the “open/close” function to control the plastic resin flow passing through the locks.

The air vent 3 has a lock that is connected with a float, floating on the free surface of the plastic resin. This float moves up and down corresponding to the level of plastic resin in the valve body (corresponding to the air content in the valve), that allows automatically opening/closing the air vent 3 corresponding to the air content in the free space in the valve main body.

The ultrasonic generator 4 mounted to the valve body plays a role in generating ultrasonic waves to the plastic resin in the valve main body, which allows accelerating the releasing speed of the air bubbles inside the plastic resin. In more detail, the ultrasonic generator 4 is made of piezoelectric material and connected to high frequency current (civil alternating current with frequency changed by an inverter). Thanks to the characteristics of piezoelectric materials, they are deformed by the application of an electrical field. Therefore, under alternating electrical charge, the ultrasonic generator will vibrate according to the alternating electrical current frequency. These vibrations engender mechanical vibrating waves on the surrounding liquid with the frequency equivalent to the applied electric current frequency.

Corresponding to the composition and the structure of the air eliminator valve mentioned above, its operating procedure is presented as follows.

In the composite manufacturing equipment system, the air eliminator valve is connected to the plastic resin storage tank by the valve inlet 5 and is connected to the mold by the valve outlet 6.

At the beginning of operation, the outlet lock 2 is closed and the inlet lock 1 is opened to allow transferring the plastic resin from the storage tank into the valve. When the plastic resin fulfills enough of the space in the valve main body 8, the air vent 3 will be closed. Because the float moves up according to the plastic resin level in the main body and the airlock connected to the float will move to airtight position.

To operate the filtering process, the ultrasonic generator 4 is active. The ultrasonic generator 4 is made of piezoelectric material and connected to an electrical alternating current of ultrasonic frequency (civil alternating current with the frequency changed by an inverter). Thanks to the characteristics of piezoelectric material, it vibrates under the application of alternating electrical charge with the frequency of the applied electrical current. These vibrations will generate mechanical vibrating waves on the surrounding plastic resin liquid.

The mechanical vibrating waves provide energy that increases the mobility of air bubbles inside the resin liquid that allows increasing the air releasing speed. On the other hands, the small air bubbles in the plastic resin move with higher speeds and higher amplitudes and could be collided to create the air bubbles in larger sizes that can move easily to the open surfaces.

While the air bubbles in the plastic resin move up to the open surface, they are released in the free space in the upper cover 7. When the air accumulates in the free space in the upper cover 7, the liquid level in the main body is also lowered. The float connected to the airlock at the air vent 3 also moves down. Thus, the air vent 3 is open and the air in the valve can go out. While the air content in the upper cover reduces, the level of liquid in the valve will lift up. The float in the resin liquid also moves up, so that the air vent 3 will be closed by the airlock connected to the float. Therefore, the air releasing from the plastic resin is again continuing the accumulation process in the upper cover. Thus, the “open/close” process of the air vent 3 is an automatic response that allows keeping stably the air content in the upper cover.

After the plastic resin in the air eliminator valve is filtered, the outlet lock 2 is opened to allow the filtered plastic resin running into the fabrication mold.

During the resin transferring process, the plastic resin from the storage tank is continuously filtered in the air eliminator valve before going into the mold. Therefore, a filtering pre-treatment process before the fabrication process is not needed. That allows reducing the time and the efforts of the composite manufacturing process.

1. Air eliminator valve for eliminating air bubbles in the plastic resin used for composite products manufacturing comprising: an inlet, an inlet lock, an air vent, an upper cover, a valve main body, an ultrasonic generator, an outlet lock and an outlet, in which:
The valve main body is composed of two cylinder structures which are perpendicularly mounted; one cylinder end is closed by the upper cover; On the upper cover, there is the air vent that controls the air releasing out of the air eliminator valve; The inlet is a connecting end with a plastic resin storage tank; The plastic resin running from the plastic resin storage tank into the valve main body is controlled by an “close/open” status of the inlet lock; The outlet is the connecting end with a mold, the plastic resin flowing through the outlet is controlled by an “open/close” status of the outlet lock;
On the valve main body, there is the ultrasonic generator, generally made of piezoelectric material; It generates the ultrasonic waves to adjacent plastic resin that allows eliminating the air bubbles out of the plastic resin;
The air vent has an airlock that is connected with a float, floating on the plastic resin in the valve; This float moves up and down corresponding to a level of plastic resin in the valve body (corresponding to the air content in the valve), that allows automatically opening/closing of the air vent corresponding to the air content in the valve.
